(19) United States
(12) Patent Application Publication
(10) Pub. No.: US 2025/0383230 A1
(43) Pub. Date: Dec. 18, 2025

(54) Adjustable and Foldable Rack with Integrated Weighing Module

(71) Applicants: Kevin Grimes, Costa Mesa, CA (US); James Grimes, Yorba Linda, CA (US)

(72) Inventors: Kevin Grimes, Costa Mesa, CA (US); James Grimes, Yorba Linda, CA (US)

(21) Appl. No.: 18/797,562

(22) Filed: Aug. 8, 2024

Related U.S. Application Data
(60) Provisional application No. 63/659,697, filed on Jun. 13, 2024.

(51) Int. Cl. G01G 21/28; G01G 3/14; G01G 23/18

(52) U.S. Cl. CPC G01G 21/28; G01G 3/14; G01G 23/18

(57) ABSTRACT

The present disclosure provides an adjustable and foldable rack featuring a platform adjustable in width, supported by at least one first leg and at least one second leg forming a cross configuration. The legs are pivotally connected at a central hinge, allowing for height adjustment and movement between collapsed and extended positions. A weighing module integrated with the platform includes sensors for detecting the weight of items, with wires extending through hollow passages in the platform to connect the sensors to a controller and a display. The display is configured to present weight data. The rack includes feet caps at the lower ends of the legs, providing ground contact and stability. The device offers a versatile and user-friendly solution for supporting and weighing items.

### FIELD OF INVENTION

The present invention relates generally to adjustable and foldable racks, particularly those designed for supporting and weighing items. It is applicable in various settings, including travel, logistics, and warehousing.

### BACKGROUND

The development of transportation and travel has significantly increased the need for efficient and user-friendly luggage handling systems. Traditional methods of handling and weighing luggage, particularly at airports and other travel hubs, often involve cumbersome processes that can cause delays and inconvenience to travelers. Existing systems primarily utilize static scales placed on the ground or countertops, which require manual lifting and positioning of luggage. This can be physically demanding and inefficient, especially for large and heavy items. Moreover, these scales are typically fixed in place, lacking mobility and flexibility in terms of placement and usage.

In addition to personal travel, logistics and warehousing industries face similar challenges. The standard practice of weighing packages often involves placing items on static scales, which can be inconvenient and inefficient, particularly in environments where space is limited, or items vary significantly in size and weight. The lack of adjustability in these systems means that users often have to adjust their handling procedures to accommodate the equipment, rather than the equipment being adaptable to their needs. This can result in slower processing times and increased labor costs.

Prior art in the field of portable and adjustable weighing devices has made some attempts to address these issues. Various designs have incorporated features such as foldable legs and adjustable heights to some extent. However, these solutions often suffer from instability when deployed, particularly when supporting heavy or unevenly distributed loads. Many designs also fail to integrate a weighing mechanism effectively, often requiring separate devices for weighing, which further complicates the process and increases the potential for errors. This approach often results in a cumbersome assembly where the weighing functionality is not seamlessly integrated into the rack's structure.

Furthermore, existing designs generally lack an efficient system for routing electrical connections, leading to exposed wiring and a higher risk of damage. The few existing disclosures that attempt to integrate weighing scales into the rack structure often require complex and costly manufacturing processes to overcome this problem. These prior solutions often necessitate custom molds and intricate designs, significantly increasing production costs. Additionally, the design of such prior art makes it difficult to manage the wiring and sensor locations, especially when the racks are designed to fold and unfold.

Another significant limitation of existing designs is their inability to accommodate varying user needs in terms of height and strength. Fixed-height systems require users to bend down or lift items to a certain level, which can be physically strenuous and inaccessible for some. While some designs offer limited adjustability, they often do not provide a smooth and intuitive mechanism for making these adjustments, leading to user frustration and potential misuse. The lack of ergonomic design considerations further exacerbates these issues, making existing solutions less than ideal for a wide range of users.

The need for a more integrated, versatile, and user-friendly system is evident, given the shortcomings of current solutions. An ideal system would combine mobility, stability, and ease of use, with a built-in weighing mechanism that provides accurate and immediate weight measurements. Such a system would not only simplify the process of handling and weighing luggage or packages but also enhance user safety and comfort.

It is within this context that the present invention is provided.

### SUMMARY

The present invention relates to an adjustable and foldable rack designed to provide a versatile and user-friendly solution for supporting and weighing items. The rack comprises a platform that is adjustable in both width and height, supported by at least one first leg and at least one second leg forming a cross configuration. The legs are pivotally connected at a central hinge, allowing them to move between collapsed and extended positions, thereby changing the height of the platform simultaneously with the width when adjusted. The platform includes a weighing module with sensors for detecting the weight of items placed on it, and a display for presenting the weight data. Wires extend through hollow passages in the platform, connecting the sensors to a controller and the display.

The unique construction of the present device, which positions the legs and weight module at two or more points of contact between the legs and the top rail platform, allows the wiring to be efficiently routed through hollow passages in the platform rails. This design facilitates the use of standard extrusion processes for the rails, thereby reducing the need for specialized manufacturing techniques and molds. Consequently, this integrated approach not only enhances the durability and functionality of the rack but also significantly lowers production costs. The ability to seamlessly incorporate the weighing functionality into the rack's structure, without compromising the foldability or operational efficiency, sets this invention apart from existing solutions.

In some embodiments, the platform includes telescopic rails, allowing it to extend and contract smoothly. This feature provides flexibility in adjusting the platform width to accommodate various item sizes.

In further embodiments, the telescopic rails are constructed from lightweight materials, such as aluminum alloys or carbon fiber composites. This choice of materials offers a balance of strength and reduced weight, facilitating easy handling and transport.

In yet further embodiments, a locking mechanism associated with the telescopic rails includes a spring-loaded pin system. This mechanism secures the platform at the desired width, ensuring stability during use.

In some embodiments, the hinge mechanism includes a cam-lock system that allows the legs to be secured at various angles. This feature enables the rack to maintain stability at different heights, accommodating different user needs and item sizes.

In further embodiments, the feet caps at the lower ends of the legs comprise a curved bottom surface. These feet caps help distribute weight evenly and enhance stability, particularly on uneven surfaces.

In yet further embodiments, the rack includes a battery as a power supply. The battery may be a standard disposable type or a rechargeable lithium-ion or other suitable type. This provides a convenient and portable power source for the electronic components, including the weighing module and display.

In some embodiments, the display is an LCD or OLED screen integrated into the platform or mounted externally. This allows for clear and accessible presentation of weight data and other relevant information.

In further embodiments, the weighing module includes strain gauge sensors positioned in housings at the contact points between the platform and the upper ends of the legs. These sensors accurately measure the weight of items placed on the platform.

In yet further embodiments, the rack includes a user interface with buttons for controlling various functions, such as locking mechanisms, tare adjustments, and unit selection. This interface provides ease of use and enhances the user's ability to operate the rack effectively.

In some embodiments, the controller includes a microcontroller unit that processes data from the sensors and communicates with the display. This integration ensures accurate and real-time data presentation.

In yet further embodiments, the platform includes a compartment for housing the controller and battery. This compartment is designed for easy access, facilitating maintenance and battery replacement.

In some embodiments, the display includes an auto-sleep mode feature to conserve battery power when the rack is not in use. This power-saving feature enhances the device's energy efficiency.

In some embodiments, adjustment of the width of the platform causes a simultaneous corresponding adjustment in the height of the legs, and vice versa.

### BRIEF DESCRIPTION OF THE DRAWINGS

Various embodiments of the invention are disclosed in the following detailed description and accompanying drawings.

FIG. 1 illustrates an example of the adjustable and foldable rack in an operational configuration, showing the overall structure and key components.

FIG. 2 illustrates an example of the top platform with telescopic rails shown transparent, highlighting the internal wiring between the weighing module sensors and the display.

FIG. 3A illustrates an example of the rack in its fully contracted configuration, showing the highest and narrowest position.

FIG. 3B illustrates an example of the rack in its fully expanded configuration, suitable for storage or shipping.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “platform” refers to the upper surface of the adjustable and foldable rack designed to support items placed upon it. This includes, but is not limited to, a flat surface that can be adjusted in width via telescopic rails. In one example implementation, the platform may be constructed from aluminum alloy with telescopic sections made from carbon fiber composites, providing both strength and lightness. The platform may also include integrated components such as a weighing module and display, which are housed within or attached to the platform.

The term “weighing module” refers to the component of the rack responsible for measuring the weight of items placed on the platform. This includes, but is not limited to, sensors, such as strain gauge sensors, that detect changes in electrical resistance due to applied weight. In one example implementation, the weighing module comprises strain gauge sensors located at the contact points between the platform and the legs. These sensors may be connected to a microcontroller unit via wires running through hollow passages in the platform, ensuring accurate weight measurement.

The term “legs” refers to the structural components that support the platform and allow for height adjustment. This includes, but is not limited to, at least one first leg and at least one second leg forming a cross configuration, pivotally connected at a central hinge. In one example implementation, the legs may consist of tubular steel or aluminum, with a cam-lock system at the hinge for securing the legs in various positions. The legs may also feature an adjustable mechanism, such as a spring-loaded pin, to lock them at different heights.

The term “feet caps” refers to the components attached to the lower ends of the legs, providing contact with the ground and enhancing stability. This includes, but is not limited to, rounded caps made from materials such as high-density polyethylene (HDPE). In one example implementation, the feet caps may have a convex bottom surface to distribute weight evenly and may in some examples include a swivel mechanism to facilitate smooth movement across different surfaces.

The term “display” refers to the component that visually presents weight data and other relevant information to the user. This includes, but is not limited to, LCD or OLED screens that may be integrated into the platform or mounted externally. In one example implementation, the display could be an LCD screen embedded within a compartment in the platform, protected by a transparent cover, and capable of showing weight measurements, tare settings, and unit selection.

The term “controller” refers to the electronic component that processes data from the sensors and controls the display. This includes, but is not limited to, a microcontroller unit (MCU) that converts sensor signals into readable weight data. In one example implementation, the controller may be housed in a compartment within the platform and connected to both the sensors and the display via shielded wiring to minimize electromagnetic interference. The controller may also include features such as auto-sleep mode for power conservation and a rechargeable battery pack as a power source.

### DESCRIPTION OF DRAWINGS

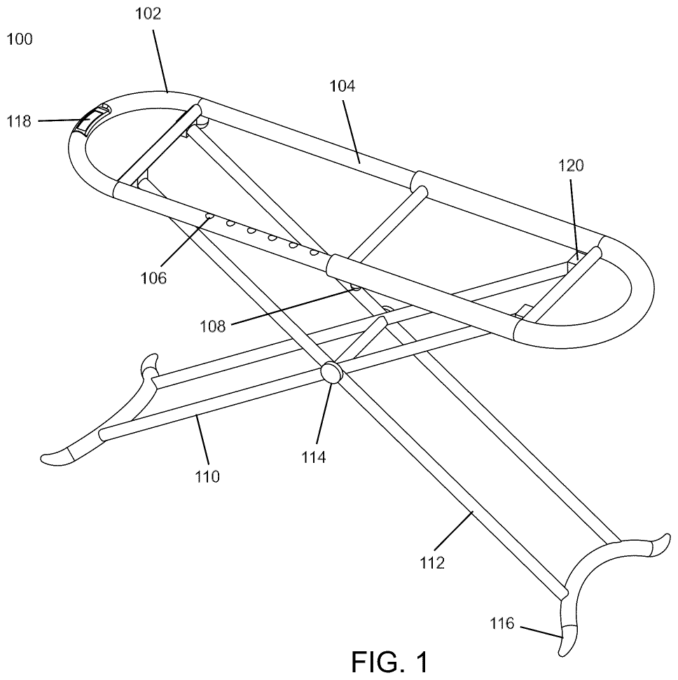

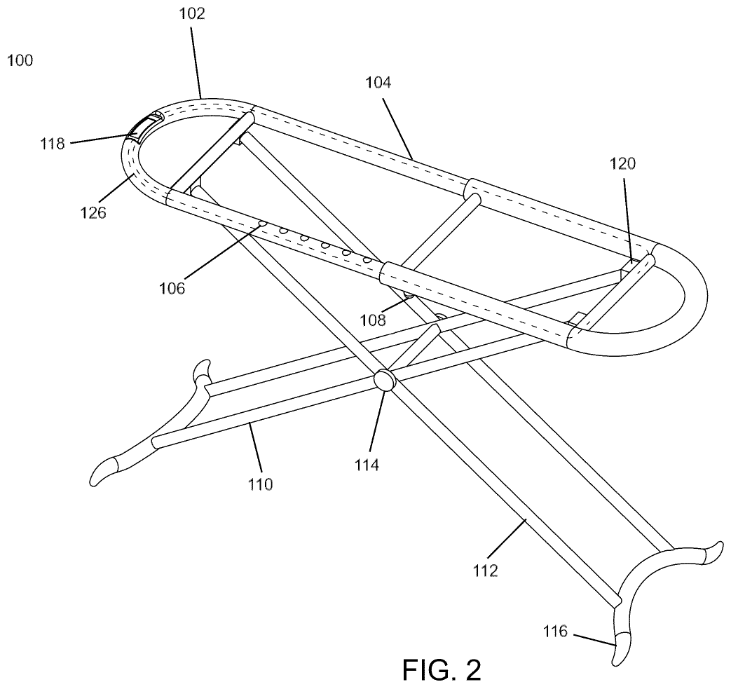

FIG. 1 illustrates an adjustable and foldable rack (100) designed to support and weigh items, particularly suitable for luggage. The rack comprises a platform (102), which includes telescopic rails (104) that allow the platform width to be adjusted at the same time as the height. The telescopic rails are constructed from lightweight materials such as aluminum alloys or carbon fiber composites, providing a balance of strength and lightness. These rails feature multiple holes (106) along their length, which are used in conjunction with a spring-loaded push pin mechanism (108) for locking the platform at various widths.

The rack is supported by a pair of legs, including at least one first leg (110) and at least one second leg (112), forming a cross configuration. These legs are pivotally connected at a central hinge (114), allowing the rack to be adjusted in height as the telescopic rails of the top platform are extended or retracted. The central hinge may in some examples be equipped with a cam-lock system, which can secure the legs at different angles, ensuring stability at various heights. The legs themselves are constructed from materials such as tubular steel or aluminum, providing durability and structural integrity.

At the lower ends of the legs, rounded feet caps (116) are attached, providing stable contact with the ground. These feet caps are made from high-density polyethylene (HDPE) and feature a convex bottom surface to distribute weight evenly and enhance stability. In some embodiments, the feet caps may also include a swivel mechanism, allowing for slight adjustments in orientation and facilitating smooth movement across different floor surfaces.

Integrated into the platform (102) is a weighing module (120) comprising several sensors, such as strain gauge sensors. These sensors are positioned at strategic contact points between the platform and the upper ends of the legs, accurately detecting the weight of items placed on the platform. The weighing module is connected to a controller via wires that extend through hollow passages within the platform. These wires are shielded to minimize electromagnetic interference and insulated for protection against environmental factors.

A display (118) is operatively connected to the weighing module and the controller, providing real-time weight data to the user. The display is an LCD or OLED screen integrated into the platform or mounted externally, offering a clear and accessible presentation of information. The controller, which processes data from the sensors, is housed in a compartment within the platform. This compartment also accommodates a rechargeable lithium-ion battery pack, providing power to the electronic components. The battery pack may include a feature for easy replacement or recharging, accessible through a designated panel.

The rack may also feature a user interface with buttons for controlling various functions, such as adjusting the locking mechanisms, setting tare weights, and selecting measurement units. The user interface is designed for ease of use, allowing users to operate the rack efficiently and effectively. Additionally, the platform (102) may include a protective coating or treatment to enhance durability and corrosion resistance, ensuring the longevity of the device in various environments.

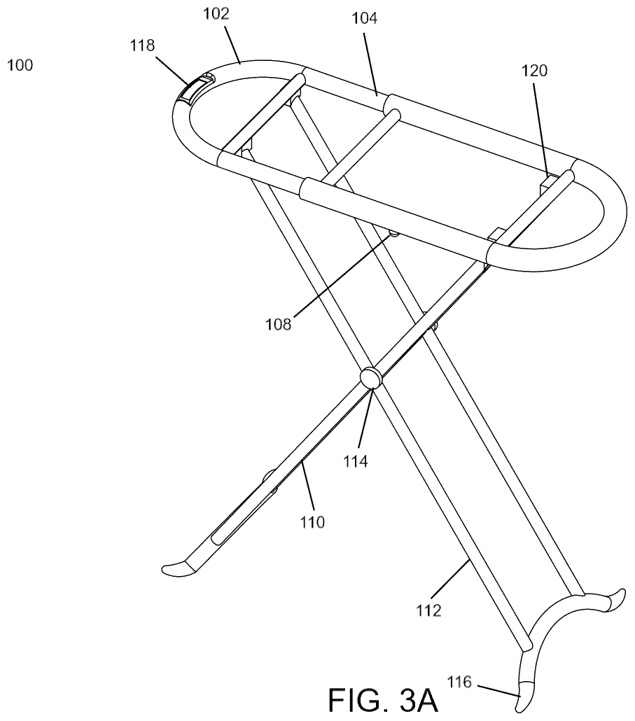

FIG. 2 provides a detailed view of the top platform (102) from FIG. 1, with a focus on the internal structure and wiring components. The telescopic rails (104) are depicted in a transparent manner, allowing the internal wiring to be visible. The wiring (122) extends through hollow passages within the telescopic rails, connecting the strain gauge sensors of the weighing module (120) to the controller and display (118). This configuration ensures that all electronic components are neatly housed within the platform structure, protecting them from external elements and physical damage.

The spring-loaded push pin mechanism (108), visible on the telescopic rails, allows for manual adjustment of the platform's width. The push pins engage with the series of holes (106) along the rails, securely locking the platform at the desired width. The transparent representation of the telescopic rails emphasizes the internal wiring layout, which is crucial for the proper functioning of the weighing system. The figure illustrates how the wires are routed to avoid interference with the mechanical adjustments of the platform, ensuring both electronic integrity and user safety.

This configuration facilitates the communication of weight data from the sensors to the display, enabling real-time updates. The streamlined design allows for efficient power distribution from the battery pack, housed within the platform's compartment, to all necessary components. The illustration demonstrates the integration of electronic and mechanical systems within the rack, highlighting the innovative aspects of the internal design.

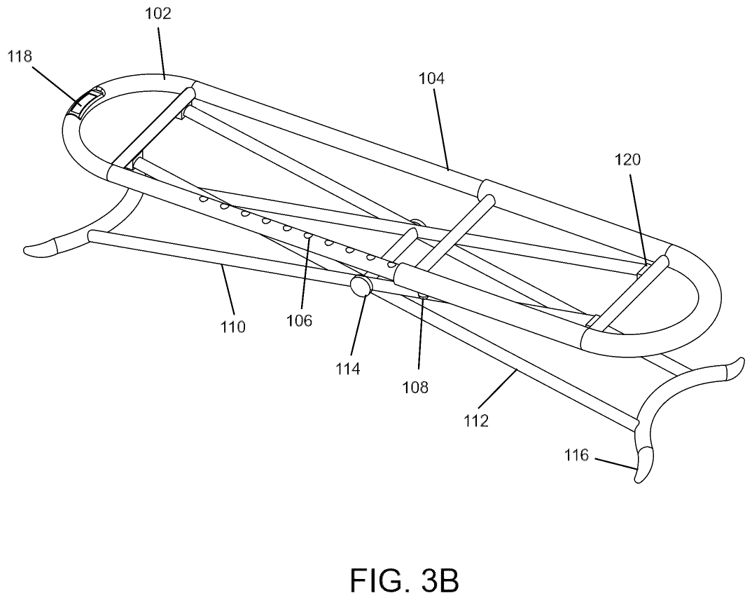

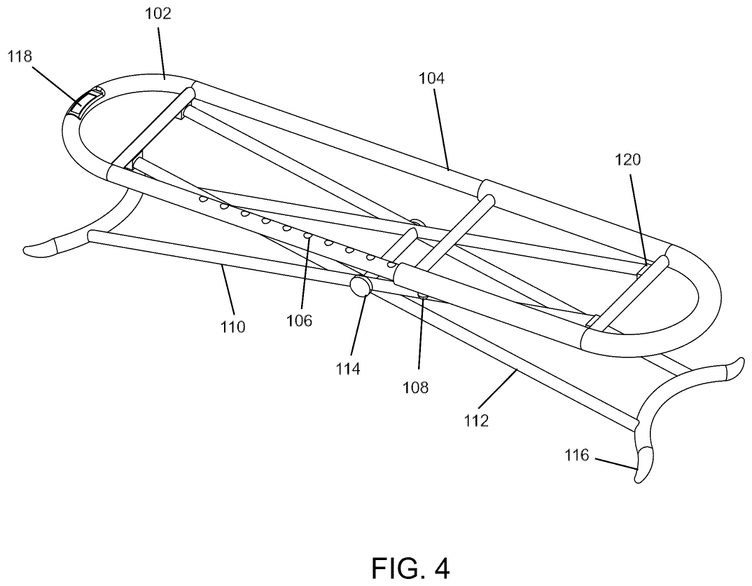

FIG. 3A depicts the adjustable and foldable rack (100) in its fully contracted configuration, representing the highest and narrowest position. In this state, the telescopic rails (104) of the platform (102) are fully retracted, minimizing the width of the platform. The legs, including the first leg (110) and second leg (112), are adjusted to their maximum height and narrowest stance, with the central hinge (114) fully extended. The spring-loaded push pin mechanism (108) secures the telescopic rails in this contracted position, and the feet caps (116) provide stable contact with the ground.

FIG. 3B illustrates the rack (100) in its fully expanded configuration, suitable for storage or shipping. In this mode, the platform (102) and telescopic rails (104) are fully extended, maximizing the width of the platform. The legs (110, 112) are positioned in their most compact form, with the central hinge (114) collapsed, bringing the upper and lower ends of the legs closer together. This configuration allows the rack to be stored in a flat, compact state, with the legs lying parallel to the platform. The rounded feet caps (116) are also shown aligned with the platform, contributing to the compactness and ease of storage.

The wiring (122) running through the hollow passages in the telescopic rails remains protected and secured in both configurations, ensuring that the connections between the weighing module (120), sensors, controller, and display (118) are maintained without interference. The design allows for quick transitions between the fully contracted and fully expanded states, offering convenience for users who need to transport or store the rack. The spring-loaded push pin mechanism (108) and the cam-lock system facilitate easy adjustment and secure locking in both configurations.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the foldable rack of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An adjustable and foldable rack comprising:
a platform, the platform being adjustable in width and including a top surface for supporting items;
at least one first leg and at least one second leg, the first and second legs being pivotally connected at a central hinge and forming a cross configuration, the legs being adjustable in height and configured to move between a collapsed position and an extended position;
a hinge mechanism, operably connecting the first and second legs at the central hinge, the hinge mechanism allowing the legs to pivot between the collapsed and extended positions;
a set of feet caps disposed at the lower ends of the legs, the feet caps providing contact with the ground;
a weighing module, integrated with the platform and disposed at contact points between the platform and the upper ends of the legs, the weighing module comprising sensors for detecting the weight of items placed on the platform;
wires operatively connected to the sensors of the weighing module, extending through hollow passages within the platform and connecting the sensors to a controller and a display; and
a display, operatively connected to the weighing module and the controller, the display configured to present weight data detected by the sensors.

2. The adjustable and foldable rack of claim 1, wherein the platform comprises telescopic rails, allowing the platform to extend and contract in width.

3. The adjustable and foldable rack of claim 2, wherein the telescopic rails are constructed from lightweight materials selected from the group consisting of aluminum alloys and carbon fiber composites.

4. The adjustable and foldable rack of claim 1, further comprising a locking mechanism associated with the telescopic rails, the locking mechanism being a spring-loaded pin system configured to engage with pre-drilled holes in the telescopic rails to secure the platform at a desired width.

5. The adjustable and foldable rack of claim 1, wherein the hinge mechanism includes a cam-lock system that allows the legs to be secured at various angles, thereby providing stability at different heights.

6. The adjustable and foldable rack of claim 1, wherein the feet caps include a convex bottom surface to evenly distribute weight and enhance stability.

7. The adjustable and foldable rack of claim 1, further comprising a power supply, wherein the power supply is a rechargeable lithium-ion battery pack configured to provide power to the weighing module, controller, and display.

8. The adjustable and foldable rack of claim 1, wherein the display is an LCD or OLED screen integrated into the platform or mounted externally, the display being configured to show weight data and other relevant information.

9. The adjustable and foldable rack of claim 1, wherein the weighing module includes strain gauge sensors that are positioned in housings located at the contact points between the platform and the upper ends of the legs.

10. The adjustable and foldable rack of claim 1, further comprising a user interface, the user interface including buttons for controlling the locking mechanisms, tare adjustments, and unit selection.

11. The adjustable and foldable rack of claim 1, wherein the controller includes a microcontroller unit configured to process data from the sensors and communicate with the display.

12. The adjustable and foldable rack of claim 1, wherein the platform includes a compartment for housing the controller and battery, the compartment being accessible for maintenance and battery replacement.

13. The adjustable and foldable rack of claim 1, wherein the display further comprises an auto-sleep mode feature to conserve battery power when the rack is not in use.

14. The adjustable and foldable rack of claim 1, wherein adjustment of the width of the platform causes a simultaneous corresponding adjustment in the height of the legs, and vice versa.
